(19) United States
(12) Patent Application Publication
(10) Pub. No.: US 2026/0227952 A1
(43) Pub. Date: Aug. 6, 2026

(54) PERSONALIZED AMBIENT SOUND PLAYBACK

(71) Applicant: AUDIODO AB (PUBL), MALMÖ (SE)

(72) Inventors: John PHILIPSSON, MALMÖ (SE); Jonas LUNDBÄCK, VELLINGE (SE)

(73) Assignee: AUDIODO AB (PUBL), MALMÖ (SE)

(21) Appl. No.: 19/152,996

(22) PCT Filed: Jan. 31, 2024
(86) PCT No.: PCT/SE2024/050081

§ 371 Date: Aug. 1, 2025

(30) Foreign Application Priority Data
Feb. 1, 2023 (SE) 2350092-9

(51) Int. Cl. G06F 3/16; H04R 1/10; H04R 3/00

(52) U.S. Cl. CPC G06F 3/165; H04R 1/10; H04R 3/00

(57) ABSTRACT

A method for providing personalized ambient sound playback, ASP, calibration data associated with an audio device and a specific user is presented. The methods comprises processing a digital representation of a first specific external sound based on an initial set of frequency dependent processing parameters and generating, by the audio device when worn by the specific user, a first internal sound based on the processed digital representation of the first specific external sound. The method further comprises adjusting the initial set of frequency dependent processing parameters based on obtained first feedback data and providing these as ASP calibration data for the audio device when worn by the specific user.

### TECHNICAL FIELD

The present invention relates to audio processing and more precisely to audio processing of ambient sound in an audio device.

### BACKGROUND

Access to audio in all its forms have increased greatly with the introduction of portable electronics equipment such as the Walkman® and later mobile phones. An audio book, a favorite song or an interesting podcast is always within reach.

This has led to several innovations within audio devices and sound control. One revolutionary innovation is the ability to provide personal sound to a user of a playback device. This comprises adapting the sound played to compensate for any hearing deviations of the user. Further innovations comprise control of an ambient sound such that external noise from e.g., fans or vehicles can be attenuated or even cancelled. This is generally known as active noise cancellation or active noise control, ANC. Further to this, some devices implement advanced equalizers, EQs, that are configured and controlled based on an ambient sound. These EQs are generally known as adaptive EQs.

These innovations are all increasing the sound quality and listening experience of a user regardless of the environment at which the audio is enjoyed. However, more can be done and there is room for further improving the listening experience of the user.

### SUMMARY

It is in view of the above considerations and others that the various embodiments of this disclosure have been made. The present disclosure therefor recognizes the fact that there is a need for alternatives to (e.g. improvement of) the existing art described above. It is an object of some embodiments to solve, mitigate, alleviate, or eliminate at least some of the above or other disadvantages.

An object of the present disclosure is to enable a new type of processing of ambient sound or which is improved over prior art and which eliminates or at least mitigates the drawbacks discussed above. More specifically, an object of the invention is to provide a calibration method for personalization of ambient sound. These objects are achieved by the technique set forth in the appended independent claims with preferred embodiments defined in the dependent claims related thereto.

In a first aspect, a method for providing personalized ambient sound playback, ASP, calibration data associated with an audio device and a specific user is presented. The method comprises generating, remotely from the audio device, a first specific external sound, and obtaining, by the audio device, a digital representation of the first specific external sound. The method further comprises processing the digital representation of the first specific external sound based on an initial set of frequency dependent processing parameters, generating, by the audio device when worn by the specific user, a first internal sound based on the processed digital representation of the first specific external sound and obtaining first feedback data indicative of a similarity between the first internal sound and the first specific external sound. Further to this, the method comprises adjusting the initial set of frequency dependent processing parameters based on the first feedback data thereby obtaining a personalized set of frequency dependent processing parameters and providing the personalized set of frequency dependent processing parameters as ASP calibration data for the audio device when worn by the specific user.

In one variant, the first specific external sound is an external sound within a first frequency band and the initial set of frequency dependent processing parameters are adjusted further based on the first frequency band. This is beneficial as it increases the quality of the ASP calibration data and allows for less resource intense processing.

In one variant, the method is repeated for a second specific external sound within a second frequency band thereby obtaining second feedback data. The personalized set of frequency dependent processing parameters are further adjusted based on second feedback data associated with the second specific external sound and the second frequency band. This is beneficial as it increases the quality of the ASP calibration data.

In one variant, the first specific sound comprise frequency content also in the second frequency band and the second specific sound comprise frequency content also in the first frequency band. This is beneficial as it increases accuracy of the feedback data.

In one variant, the first specific sound comprise a frequency content being substantially wholly within the first frequency band and the second specific sound comprise a frequency content being substantially wholly within the second frequency band.

In one variant, the first frequency band and the second frequency band are selected from a set of frequency bands comprising at least two of a sub-bass region, a bass region, a low-mid region, a mid-mid region, an upper-mid region, a presence region and a details region.

In one variant, obtaining the first feedback data comprises obtaining feedback data from the specific user. This is beneficial as subjective perceptions are forming part of the feedback.

In one variant, the feedback data from the specific user is obtained by the specific user indicating feedback data in a two dimensional space wherein at least one dimension comprises an emotional indicator. This is beneficial at the accuracy of the feedback data may be increased as the user easily can provide accurate data.

In one variant, the emotional indicator is configured based on the frequency band associated with the external sound related to the feedback data. This is beneficial at the accuracy of the feedback data may be increased as the user easily can provide accurate data.

In one variant, obtaining the first feedback data comprises obtaining feedback data from a feedback microphone circuit of the audio device. This is beneficial as the method, or parts of the method, may be performed without interaction by the specific user.

In one variant, the first feedback data comprises amplitude feedback data indicative of a similarity in sound pressure level, SPL, between the first internal sound and the first specific external sound. This is beneficial as the volume of the ASP will be correct.

In one variant, adjusting the initial set of frequency dependent processing parameters based on the first feedback data is further based on one or more equal loudness contours. Equal loudness are known from e.g. the works of Fletcher and Munson and ensures that the perceived loudness is correct in relation to the set playback level.

In one variant, the method further comprises processing the digital representation of the first external sound based on the personalized set of frequency dependent processing parameters, generating, by the audio device when worn by the specific user, a personalized first internal sound based on the personalized processed digital representation of the first specific external sound, obtaining updated first feedback data indicative of a similarity between the personalized first internal sound and the first specific external sound, and adjusting the personalized set of frequency dependent processing parameters based on the updated first feedback data.

In one variant, the initial set of frequency dependent processing parameters are based on one or more calibration input parameters, wherein the calibration input parameters are one or more of a worn state of the audio device and/or a relative location of a sound generator configured to generate the first specific external sound.

In one variant, the personalized frequency dependent processing parameters and the ASP calibration data are configured with a limited bandwidth, preferably, the limited bandwidth correspond an auditory bandwidth of humans. This increases processing efficiency and reduces e.g. current consumption.

In one variant, the personalized frequency dependent processing parameters and the ASP calibration data are set to unity such that no processing is performed at frequencies below 20 Hz, preferably at frequencies below 50 Hz and most preferably at frequencies below 70 Hz. This increases processing efficiency and reduces e.g. current consumption.

In one variant, the personalized frequency dependent processing parameters and the ASP calibration data are set to unity such that no processing is performed at frequencies above 20 kHz, preferably at frequencies above 15 kHz and most preferably at frequencies above 12 kHz. This increases processing efficiency and reduces e.g. current consumption.

In one variant, the first specific external sound is a predefined sound selected from a set of sounds comprising a plurality of sounds, wherein at least one of the sounds is suitable for determining ASP calibration data associated with at least one frequency band selected from of bass region, a low-mid region, a mid-mid region, an upper-mid region, a presence region and/or a details region.

In a second aspect, an ASP calibration system is presented. The ASP calibration system comprises an audio device, a sound generator, a feedback provisioning circuit and at least one processor circuit configured to cause provisioning of ASP calibration data of a specific user and the audio device according to the method of the first aspect. The audio device comprises a feed forward microphone circuit configured to obtain digital representations of specific external sound generated by the sound generator; a transducer circuit; an input circuit configured to obtain audio data; and a processor circuit configured to process the digital representations of the specific external sound based on the ASP calibration data and sound the processed specific external sound and the audio data by means of the transducer circuit.

In a third aspect, an audio device is presented. The audio device is configured to form part of the ASP calibration system of the second aspect and thereby to obtain ASP calibration data of a specific user and the audio device according to the method of the first aspect. The audio device comprises a feed forward microphone circuit configured to obtain digital representations of external sound; a transducer circuit; and a processor circuit.

In one variant, the processor device is configured to process the digital representations of the external sound based on the ASP calibration data and sound the processed external sound by means of the transducer circuit, preferably the processor circuit is further configured to process the external sound based on a hearing profile of the specific user.

In one variant, the audio device further comprises an input circuit configured to obtain audio data across an audio interface. The processor circuit is configured to sound the audio data by means of the transducer circuit, preferably the processor circuit is further configured to process the audio data based on a hearing profile of the specific user.

In a fourth aspect, a computer-readable storage medium is presented. The computer-readable storage medium comprises program instructions which, when executed by a processor circuit, cause the processor circuit to cause execution of the method according to the first aspect.

### BRIEF DESCRIPTION OF THE DRAWINGS

Embodiments of the invention will be described in the following; references being made to the appended diagrammatical drawings which illustrate non-limiting examples of how the inventive concept can be reduced into practice.

FIG. 1 is a schematic view of an audio device according to some embodiments of the present disclosure;

FIGS. 2a-c are cross sectional views of an ear of a user wearing an audio device according to some embodiments of the present disclosure;

FIG. 3 is as a schematic view of an audio device according to some embodiments of the present disclosure;

FIG. 4 is a schematic view of an ASP calibration system according to some embodiments of the present disclosure;

FIGS. 5a-d are schematic views of ASP calibration systems according to some embodiments of the present disclosure;

FIG. 6 is a simplified signaling diagram according to some embodiments of the present disclosure;

FIG. 7 is a schematic view of a method for providing ASP calibration data according to some embodiments of the present disclosure;

FIG. 8 is a schematic view of a method for providing ASP calibration data according to some embodiments of the present disclosure;

FIG. 9 is a schematic process structure for providing ASP calibration data according to some embodiments of the present disclosure;

FIG. 10 is a schematic view of an audio device according to some embodiments of the present disclosure;

FIG. 11 is a schematic view of an audio device according to some embodiments of the present disclosure;

FIGS. 12a-c are diagrams showing frequency content and frequency bands for specific external sounds according to some embodiments of the present disclosure;

FIG. 13 is a view of a two dimensional space for providing feedback data according to some embodiments of the present disclosure;

FIG. 14 is a schematic view of a computer program and computer readable storage medium according to some embodiments of the present disclosure; and

FIG. 15 is a schematic view of loadablity of a computer readable storage medium according to some embodiments of the present disclosure.

### DETAILED DESCRIPTION OF EMBODIMENTS

Hereinafter, certain embodiments will be described more fully with reference to the accompanying drawings. The invention may, however, be embodied in many different forms and should not be construed as limited to the embodiments set forth herein; rather, these embodiments are provided by way of example so that this disclosure will be thorough and complete, and will fully convey the scope of the invention, such as it is defined in the appended claims, to those skilled in the art.

The term “coupled” is defined as connected, although not necessarily directly, and not necessarily mechanically. Similarly, the term “connected”, or “operatively connected”, is defined as connected, although not necessarily directly, and not necessarily mechanically. Two or more items that are “coupled” or “connected” may be integral with each other. The terms “a” and “an” are defined as one or more unless this disclosure explicitly requires otherwise. The terms “substantially”, “approximately” and “about” are defined as largely, but not necessarily wholly what is specified, as understood by a person of ordinary skill in the art. The terms “comprise” (and any forms thereof), “have” (and any forms thereof), “include” (and any form thereof) and “contain” (and any forms thereof) are open-ended linking verbs. As a result, a method that “comprises”, “has”, “includes” or “contains” one or more steps, possesses those one or more steps, but is not limited to possessing only those one or more steps.

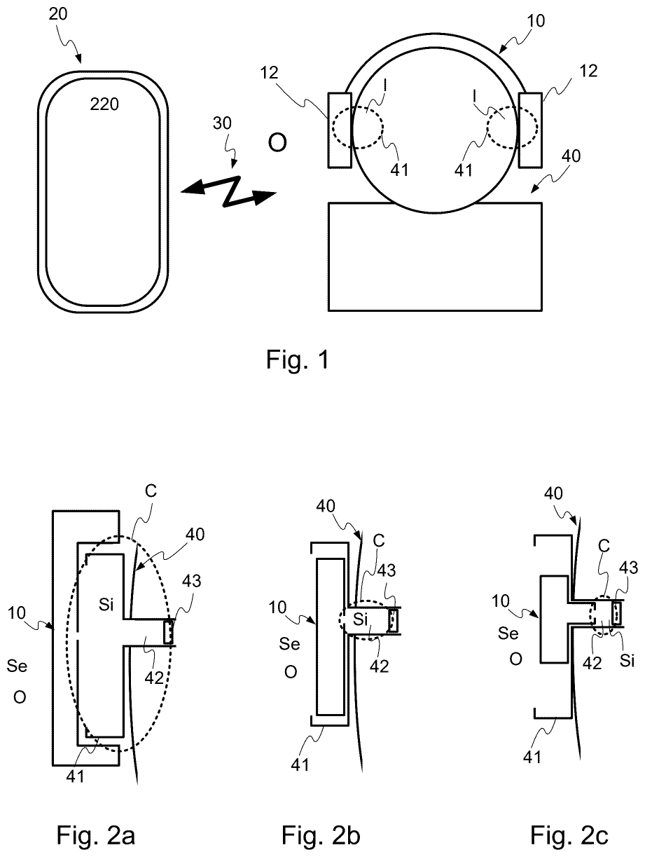

FIG. 1 shows a simplified view of an embodiment of an audio device 10 when worn by a user 40. In FIG. 1, the audio device 10 is shown as a pair of on-ear headphones. The audio device 10 of this embodiment is worn at outer ears 41 of the user 40. As will be seen in further sections of the present disclosure, this is but one example and the teachings of the present disclosure are applicable to many forms of audio devices 10 such as, but not limited to, supra-aural, circum-aural or in-ear. For the present disclosure, an audio device 10 will generally mean any device configurable to produce sound from a sound generator 220 and to engage at least one ear of the user and thereby at least partly occluding or to a degree altering the user's perception of ambient sounds (more on the latter in later sections). The sound generator 220 may be any suitable sound generator 220 operatively or directly connected to the audio device 10. In some embodiments, the sound generator 220 may be comprised in the audio device 10 (or vice versa). The sound generator 220 in FIG. 1 is illustrated as an electronics device in the form of a mobile phone 20 but it may be any suitable device such as, but not limited to, a home audio system, a portable media storage (e.g., iPod, portable MP3 player), a car audio system, portable speaker device etc. The sound generator 220 may be connected to the audio device 10 by means of any suitable audio interface 30. In some embodiments, the audio interface 30 is a wired interface such as a cord connected to the audio device 10 and connectable to the sound generator 220 by a 3.5 mm or 6.6 mm phono plug. Advantageously, the audio interface 30 is a wireless interface such as e.g., a Bluetooth, a WIFI, a 3GPP specified interface or a suitable proprietary ISM interface.

As mentioned, the audio device 10 of FIG. 1 is an on-ear device. As seen in the cross-sectional view of the user 40 and an on-ear audio device of FIG. 2a, a cavity C is formed between an eardrum 43 of the user 40 and the audio device 10. Depending on a type of the audio device 10 and a fit of the audio device 10, a size and acoustic properties (e.g., open/closed) of the cavity C may change. In FIG. 2a, where the audio device is an on-ear device, the cavity C is comparably large and comprise the outer ear 41 and the ear canal 42 of the user 40. Depending on a size of the audio device 10 in relation to a size of the out ear 41, the cavity C will be open or closed. If the cavity Cis open, it is in fluid communication with an outside O of the audio device 10. It should be mentioned that, additionally, or alternatively, the cavity C may very well be in fluid communication with the outside O through the audio device 10 and thereby form an open cavity C independent on the fit of audio device 10.

In FIG. 2b, another exemplary embodiment of an audio device 10 is shown. In this embodiment, the audio device 10 is an in-ear audio device arranged inside the outer ear 41 of the user 40. This type of audio device 10 may be referred to as an earbud and generally rest specifically on the concha, i.e., the opening of the outer ear 41 at which it connects to the ear canal 42. In this embodiment, the cavity C formed between the audio device 10 and the eardrum 43 of the user 40 comprises only a portion of the outer ear 41 (a portion of the concha) and the entire ear canal 42 between the outer ear 41 and the ear drum 43. The cavity C in FIG. 2b is smaller than the cavity formed by the audio device of FIG. 2a. Generally, this cavity C is considered open as it is challenging to achieve 10 a tight fit of the audio device 10 at the concha and an air gap will generally be formed between the audio device 10 and the concha.

In FIG. 2c, yet another exemplary embodiment of an audio device 10 is shown. In this embodiment, the audio device 10 is an in-ear audio device arranged inside the ear canal 43 of the user 40. This type of audio device may be referred to as an earphone and is generally squeezed into the ear canal 43 forming a tight fit between the audio device 10 and the ear canal 43. Consequently, the cavity C formed by this audio device comprise only a portion of the ear canal 43 and is smaller than the cavities presented with reference to FIGS. 2a and 2b. Due to the tight fit, the cavity C provided by this audio device 10 is generally considered a closed cavity, albeit a breathing valve or similar is generally introduced to provide increased comfort for the user 40.

The embodiments of the audio devices 10 presented with reference to FIGS. 2a-c are non-exhaustive examples of audio devices 10 to which the teachings of the present disclosure are applicable. As explained, each of the audio devices 10 will form a specific cavity C at the ear of the user 40. As a consequence, sound originating from the outside O of the audio device 10, i.e., ambient or outside sound generally not generated by the audio device 10, will be affected by the occlusion provided by audio device 10 before arriving at the eardrum 43 of the user 40. When the user 40 wears an audio device 10, outside sound may dampened, occluded, distorted or otherwise affected. To mitigate this, many audio devices 10 are configured with a hear-through, ambient sound functionality or ambient sound playback (ASP), through which the audio device 10 is configured to actively transfer sound from the outside O to the cavity C, i.e., to the eardrum 43 of the user 40. However, as previously explained, the sound at the cavity will be affected by the size and form of the cavity C which will, as mentioned, depend on e.g., the fit of the audio device 10. This is one issue that the inventors behind the present disclosure have identified and the teachings presented herein will enable user specific adaptation and personalization of hear-through, ambient sound functionality or ASP.

For efficiency, sounds at, or sounds originating at, the outside O of the audio device 10 may be referred to as external sounds Se, and sounds at, or sounds originating at, the cavity C may be referred to as internal sound Si.

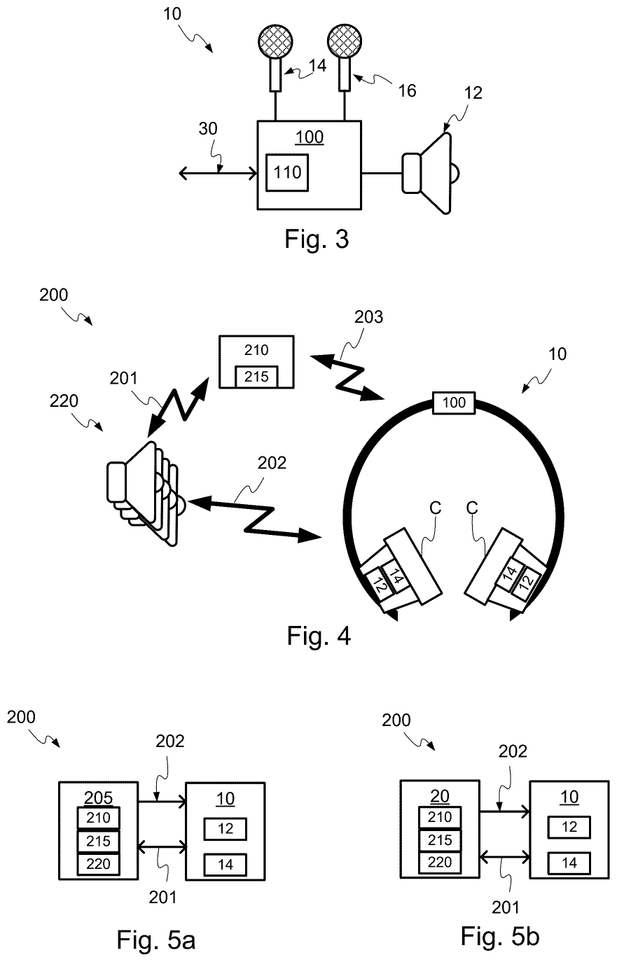

As is generally known, and schematically shown in FIG. 3, an audio device 10 comprises one or more transducer circuits 12 operatively connected to a processor circuit 100. The transducer circuit(s) 12 of the audio device 10 is configured to generate sound that spreads into the cavity C formed between the audio device 10 and the eardrum 43 of the user 40. The processor circuit 100 may be implemented as anything between an impedance matching circuit to an advanced DSP-based circuit configured to control audio provided to the transducer circuit(s) 12. For the present disclosure, the audio device 10 is assumed to comprise, or be operatively connected to a processor circuit 100 configured to execute, or cause the execution of the teachings presented herein. The processor circuit 100 may further comprise or be operatively connected to an input circuit 110 configured to interface with e.g., the sound generator 220 across the audio interface 30. Specifically, the input circuit 110 is configured to obtain audio data 112 (see FIG. 10) from an audio source. The audio source will not be further explained and the skilled person understands that the audio source may depend on the audio interface 30 and may span between sources such as a Walkman to streamed content from e.g., Spotify or YouTube. It should be mentioned that, although the processor circuit 100 of FIG. 3 is shown as comprising the input circuit 110, this is one non-limiting example, and the processor circuit 100 and the input circuit 110 may very well be separate circuits.

The audio device 10 of FIG. 3 further comprises at least one microphone circuit 14, 16. The microphone circuit 14, 16 may be any form of audio/sound sensing circuit. At least one microphone circuit 14, 16 is a feed forward microphone circuit 14. The feed forward microphone circuit 14 is advantageously configured to obtain, measure, or otherwise acquire an indication of a sound at the outside O of the audio device 10. The feed forward microphone circuit 14 is generally provided in audio devices 10 configured to be used with e.g., mobile phones 20 as the microphone 14 configured to obtain speech from the user during e.g., hands-free operation of the mobile phone 20. In addition to the above, as an optional feature, the audio device 10 may comprise a feedback microphone circuit 16. The feedback microphone circuit 16 is advantageously configured to obtain, measure, or otherwise acquire an indication of a sound at the cavity C between the audio device 10 and the eardrum 43 of the user 40. The feedback microphone circuit 16 is generally provided in audio devices 10 configured to perform active noise cancellation/control, ANC, in order to provide feedback of an amount of noise that remain at the cavity C formed between the audio device 10 and the eardrum 43 of the user 40.

The skilled person will appreciate that the schematic view of the audio device presented in FIG. 3 may not be complete and that further hardware and/or software components, modules, circuits or devices may be required to provide a fully operational audio device. For simplicity of disclosure, such features e.g., analogue to digital converters, digital to analog converters, amplifiers, transceivers etc., are not further detailed in the present disclosure as they are well known to the skilled person.

It should be mentioned that, although, in the previous section, the microphone circuits 14, 16 are shown and described as comprised in the audio device 10, one or more or all microphone circuits 14, 16 may be separate from the audio device 10 and operatively connected to the audio device across e.g., the audio interface 30.

Generally, when an audio device 10, e.g., the audio device 10 of FIG. 3, is operating in an ASP mode, the feed forward microphone circuit 14 may be configured to obtain (record, measure, sense) external sound Se at the outside O (not indicated in FIG. 3). The obtained external sound Se is then sounded by the transducer circuit 12 to provide an internal sound Si at the cavity C formed by the audio device 10 at the ear of the user 40. The obtained external sound Se may be processed by, for instance, the processor circuit 100 to compensate for e.g., damping and/or occluding effects of the audio device 10.

However, as there is a great difference in how sounds are perceiver and transferred from the outside O of the audio device 10 to the cavity C, e.g., the inside of the audio device 10, obtaining suitable processing parameters for processing of the external sound Se is very challenging. As previously mentioned, the transfer of external sound Se is influenced by numerous factors such as the fit of the audio device 10, the type of external sound Se etc. The inventors behind the present disclosure have realized that there is a need for a personalization process in adjusting the ASP.

As previously indicated, for a specific user 40, the perception of an external sound Se is dependent on the individuals' anatomic details (size, geometry etc.) of the upper body and ear (outer ear 41 and ear-canal 42). Specifically, such anatomic details may depend on a size of head and shoulder of the user 40, an outer ear geometry, an ear canal diameter and depth etc. In some examples, the ASP may be provided with a default-configured (non-personified) and tuned using acoustic equipment that model a human with anatomic details that are established by averaging over a large set of humans. As a result, such a non-personified ASP may therefore sound less natural since the configuration is not suitable for a specific user 40 having e.g., specific ear and upper body size and geometry, headphone placement and/or fit that differs compared to the those of the acoustic equipment.

The inventors have realized that a personalization of the ASP will result in a more natural external sound Se, i.e., ambient sound, perceived by the specific user 40.

For the sake of explanation and throughout the present disclosure, a natural sounding ASP, is an ASP wherein a difference in perception of an external sound Se perceived when wearing the audio device 10 with personified ASP and perception of the same external sound Se when not wearing any audio device 10 is comparably small. That is to say, comparing an audio device 10 with ASP (hear-though) without personalization active, to the audio device 10 with ASP active, a difference in perception of external sound Se when wearing the audio device 10 and when not wearing the audio device 10 is reduced when personalized ASP is active. In order to provide this, the ASP needs to be personalized and ASP calibration data for each specific user 40 is required.

In order to provide this, one way would be to place the user 40 in an anechoic chamber while wearing microphones inserted into the ear-canals 42. The user 40 may then be subjected to a plurality of sounds from a sound source which the microphones in the ear-canals would detect. Such sounds may be e.g., pure tone sinusoidal test signals. In such an environment, it would be possible to accurately obtain what may be referred to as an open-ear frequency transfer function of the user 40. This would constitute the reference frequency response for the open ear. However, the technical implications of such an implementation are many e.g., a depth of microphones in the ear-canal 43, sound source properties (diffuse sound field of noise or point source with chirp), source impact removal, microphone frequency response etc. Further to this, such an approach is cumbersome and technically challenging. Either way, a second measurement as above would have to be performed wherein the user 40 is wearing the audio device 10 with ASP active. This would result in an occluded ear frequency response. In order to personalize the ASP processing, the ASP may be adjusted such that the occluded ear frequency response equals a reference (open ear) frequency response. However, this is only partly true since there are other properties that may impact the sound quality. Such properties may be based on e.g., a delay of the processed audio. Preferably, the delay of the processed audio should not be too long, since an extended delay may in some cases be perceived as an echo of any leakage signal transferring from the outside O to the cavity C, i.e., external sound Se leaked into the ear-canal 42. Further properties relate to any difference in processing between e.g., a left audio device 10 and a right audio device 10, or between a left and right earpiece of a stereo audio device 10. If there is a significant difference in the processing, this will affect the user's ability to perceive the binaural ques (interaural-magnitude, -delay and -coherence) and an ability to determine where an external sound Se originated from. In addition, just listening to sinusoidal signals (pure tones) is cumbersome and for complete evaluation of an open and occluded frequency responses, many iterations with different frequencies are generally required. On the other hand, listening to an audio signal with full bandwidth and detailing properties in sub-bands is very difficult. That is to say, to render a music track and asking the user 40 to adjust the ASP processing with multiband equalizer is only suitable for an experienced audio engineer and not a general consumer of audio content. A further apparent drawback is that it would be very cumbersome and expensive to allow each user 40 to be evaluated in an anechoic chamber.

The inventors behind the present disclosure have realized that there is a need for a personalization process and therein identified the above problems. There is a need to provide an efficient and flexible personalization process. Advantageously, such a process may be configured to propose and/or recommend adjustment to properties in cases when e.g., the user 40 is unable to decide or conclude on a way forward. The inventors have further realized that this may be provided by utilizing specific external sounds Se when determining the ASP calibration data. In doing this, it is possible to provide ASP calibration data 303 (see FIG. 9) at any suitable location where such a specific sound Se may be reliably generated.

To this end, an ASP calibration system 200 will be presented with reference to FIG. 4. The ASP calibration system 200 comprises an audio device 10 that may be any suitable audio device 10 presented within the present disclosure. The audio device 10 comprises at least one transducer circuit 12 and at least one feed forward microphone circuit 14. Preferably, the audio device 10 comprises at least one processing circuit 100, but in some embodiments, the audio device 10 may be operatively connected to a suitable processing circuit 100. The ASP calibration system 200 further comprises at least one sound generator 220 located remote from the audio device 10. The sound generator 220 is configurable to generate a specific external sound Se. The ASP calibration system 200 may optionally comprise an ASP calibration processing circuit 210 and/or a feedback provisioning circuit 215. As seen in the example of FIG. 4, the ASP calibration processing circuit 210 is configured to communicate with the sound generator 220 across a first interface 201. The sound generator 220 is configurable to communicate, or rather provide, the specific external sound Se to the audio device 10 across a second interface 202. The audio device 10 is configurable to communicate with the ASP calibration processing circuit 210 across a third interface 203. The first interface 201 and the third interface 203 may be any suitable interfaces such as a wired interface or wireless interface, e.g., a Bluetooth interface. The second interface 202 is preferably direct air interface transferring sound (i.e., changes in air pressure) generated by the sound generator 220.

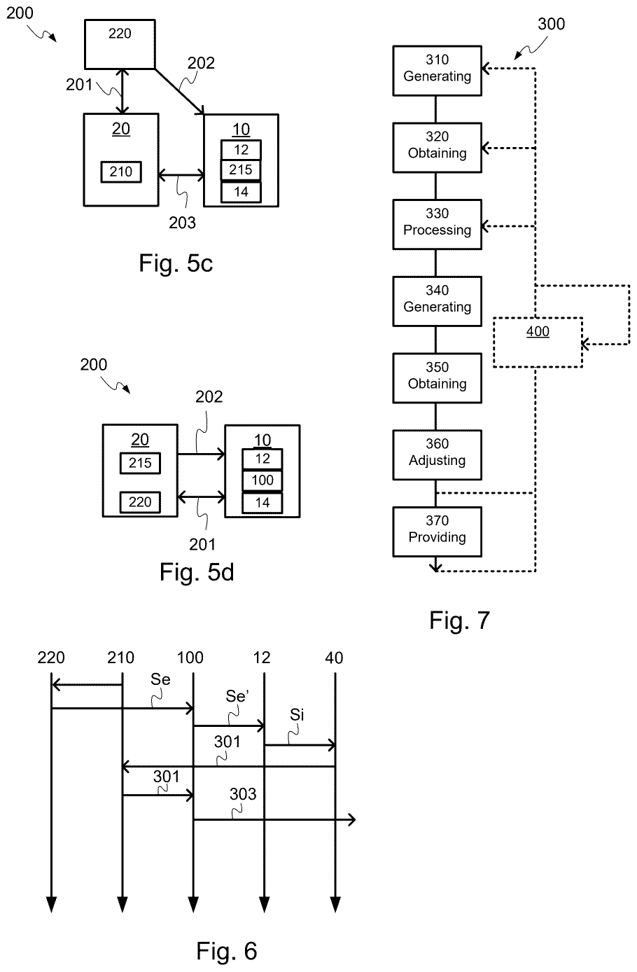

The schematic view of the ASP calibration system 200 shown in FIG. 4 is one example. The ASP calibration system 200 may be configured and/or formed in a plurality of different ways, all of which are well within the scope of the present disclosure. In FIG. 5a, an exemplary block diagram of the ASP calibration system 200 according to a different configuration is shown. In this configuration, the ASP calibration system 200 comprises an ASP calibration device 205 which is shown comprising the ASP calibration processing circuit 210, the feedback provisioning circuit 215 and the sound generator 220. The audio device 10 comprise the feedback microphone circuit 14 and the transducer circuit 12.

In FIG. 5b, another exemplary block diagram of the ASP calibration system 200 is shown. In this configuration, the ASP calibration system 200 comprises the mobile phone 20 which is shown comprising the ASP calibration processing circuit 210, the feedback provisioning circuit 215 and the sound generator 220. It should be mentioned that the functions (will be detailed in further sections) of the ASP calibration processing circuit 210, the feedback provisioning circuit 215 and the sound generator 220 may be performed by circuitry comprised in a general mobile phone 20. To exemplify, the ASP calibration processing circuit 210 may be a processor circuit of the mobile phone 20, the feedback provisioning circuit 215 may be a user interface comprising a touch interface of the mobile phone 20 and the sound generator 220 may be a loudspeaker of the mobile phone 20. The audio device 10 comprises the feedback microphone circuit 14 and the transducer circuit 12.

In FIG. 5c, another exemplary block diagram of the ASP calibration system 200 according to a configuration is shown. In this configuration, the ASP calibration system 200 comprises a mobile phone 20 which is shown comprising the ASP calibration processing circuit 210. The feedback provisioning circuit 215 is in this embodiment comprised in the audio device 10 together with the feedback microphone circuit 14 and the transducer circuit 12. The feedback provisioning circuit 215 may be realized by means of e.g., input buttons/sensors (e.g., volume buttons/sensors) at the audio device 10. The sound generator 220 is, in this exemplary embodiment, a stand-alone device operatively connected to the mobile phone 20 across the first interface 201. The sound generator 220 may be e.g., a portable Bluetooth speaker or one or more network speakers such as, but not limited to, Google Audio or Sonos enabled devices.

In FIG. 5d, another exemplary block diagram of the ASP calibration system 200 according to a configuration is shown. In this configuration, the ASP calibration system 200 comprises a mobile phone 20 which comprises the feedback provisioning circuit 215 and the sound generator 220. The audio device 10 comprises the processor circuit 100, the feedback microphone circuit 14 and the transducer circuit 12. This implies that the functionality of the ASP calibration processing circuit 210 is performed by the processor circuit 100 of the audio device 10.

From FIG. 4 and FIGS. 5a-d it is made clear that the composition and arrangement of the different devices of the ASP calibration system 200 may be in many different ways. In addition to what has been shown, it should be mentioned that e.g., the functionality of the ASP calibration processing circuit 210 (will be detailed in later sections) may be distributed across a plurality of processing circuits 100, 210 and devices 10, 20, 205.

With this in mind, an exemplary signaling diagram of a method 300 (see FIG. 7) for providing personalized ambient sound playback will be presented with reference to FIG. 6. The calibration method 300 is performed for a specific user 40 and a specific audio device 10. The calibration method 300 may be initiated by the ASP calibration processing circuit 210 configuring the sound generator 220 to generate a first specific external sound Se. The first specific external sound Se will be further explained in later sections. The first specific external sound Se is provided to the processor circuit 100 of the audio device 10 e.g., by means of the feed forward microphone circuit 14. There may be filtering, analogue to digital conversion etc. involved in this process but this is all well within the knowledge of the skilled person. The processor circuit 100 will process the first specific external sound Se and provide a processed internal sound Se′ to the transducer circuit 12 of the audio device 10. The transducer circuit 12 will generate a first internal sound Si audible to the specific user 40, i.e., at this stage, the user 40 preferably wears the audio device 10. That is to say, the internal sound Si is propagating in the cavity C. Based on the first internal sound Si, the ASP calibration processing circuit 210 obtains first feedback data 301 indicative of a similarity between the first internal sound Si and the first specific external sound Se. The first feedback data 301 may be provided by the user through e.g., the feedback provisioning circuit 215. Alternatively, or additionally, in embodiments wherein the audio device comprises the feedback microphone circuit 16, the feedback microphone circuit 16 may provide all or part of the first feedback data 301. If the specific user 40 provides the feedback data 301, it may be provided as a subjective indication resulting from a comparison of a perceived sound when listening to the first specific external sound Se when not wearing the audio device 10 compared to when wearing the audio device and listening to the first internal sound Si. In this exemplary embodiment, wherein the ASP calibration processing circuit 210 is shown as separate from the processing circuit 100 (although they may be separate software functions or modules executed by the same physical device), the first feedback data 301 is provided to the processing circuit 100. This allows the processing circuit 100 to adjust an initial set of frequency dependent processing parameters 123, see FIG. 9, based on the first feedback data 301. This provides a personalized set of frequency dependent processing parameters 125, see FIG. 9. The processing circuit 100 may then provide the personalized set of frequency dependent processing parameters 125 as ASP calibration data 303 for future ASP processing. The ASP calibration data 303 will be specific for the specific user 40 when wearing the audio device 10.

With reference to FIG. 7, the method 300 for providing personalized ASP calibration data 303 will be outlined in some more detail. The method 300 may be referred to as a personalization process, ASP personalization etc. Note that the different tasks described with reference to the method 300 are not necessarily performed by the same device. The tasks may be performed by any suitable device or devices mentioned in the present disclosure. The features of the method that will be detailed with reference to FIG. 7 are exemplary features and the method may very well comprise any other suitable feature presented herein.

One step of the method 300, comprises generating 310 the first specific external sound Se. The first specific external sound Se is generated remotely from the audio device 10. The first specific external sound Se is advantageously generated by the sound generator 220. In some embodiments, the first specific external sound Se is an external sound within a first frequency band (sometimes referred to as frequency region) and the initial set of frequency dependent processing parameters 123 are adjusted based on the first feedback data 301 and the first frequency band. The initial set of frequency dependent parameters 123 are consequently personalized based on the feedback 301 from the specific user 40, and form a personalized set of frequency dependent processing parameters 125.

It should be mentioned already here, that the method 300, preferably in full, may be repeated for a second specific external sound Se wherein the second specific external sound Se may be within a second frequency band. From this follows that the personalized set of frequency dependent processing parameters 125 are adjusted based on second feedback data 301 associated with the second specific external sound Se and the second frequency band in addition to the first feedback data 301 and the first frequency band as previously explained. As will be explained, there may be several specific external sounds Se suitable for each frequency region, and the method 300 may be repeated for the same frequency region but with a different specific external sound Se.

Another step of the method 300 comprises obtaining 320, by the audio device 10, the first specific external sound Se. As previously indicated, this is preferably achieved by the feed forward microphone 14 of the audio device 10. Generally, a microphone 14 converts sound to an analogue electric representation of sensed sound, in this case the first specific external sound Se. As any further processing is likely to be performed in a digital domain, the obtaining 320 generally comprises converting the analogue electric signal to a digital representation of the first specific external sound Se.

The method 300 further comprises processing 330 the obtained first specific external sound Se. As the processing 330 is advantageously performed in the digital domain, it is the digital representation of the first specific external sound Se that is processed. The processing 330 is performed based on the initial set of frequency dependent processing parameters 123. The initial set of frequency dependent processing parameters 123 may be a set of factory present frequency dependent processing parameters 123 provided with the audio device 10. In some embodiments, the initial set of frequency dependent processing parameters 123 may comprise e.g., filter parameters comprising gain parameters for a plurality of frequencies. In further embodiments, a gain of the filter parameters of the initial set of frequency dependent processing parameters 123 may be set to unity, i.e., no gain is added.

In some embodiments, the initial set of frequency dependent processing parameters 123 are based on one or more calibration input parameters 121 (see FIG. 9) that are advantageously provided during e.g., a setup of the method 300. The calibration input parameters 121 may comprise user specific data such as an age of the user etc. The calibration input parameters 121 may additionally, or alternatively, be based on one or more of a worn state of the audio device 10. The worn state may describe if the audio device 10 is in e.g., an in-ear, earbud or over-ear configuration. The calibration input parameters 121 may additionally, or alternatively, comprise an indication of a relative location of the sound generator 220, e.g., a distance and/or a direction from the audio device 10. One or more of the calibration input parameters 121 such as worn state, user specific data, relative location of the sound generator 220 etc. may be provided by the specific user 40 through e.g., the feedback provisioning circuit 215 or any other suitable input device. In some embodiments, one or more of the calibration input parameters 121 may be obtained from a remote data storage such as a cloud server or similar. The skilled person will appreciate that there may be many more ways of obtaining these parameters e.g., depending on the type of audio device 10 and sound generator 220. To exemplify, if the sound generator 220 is a Bluetooth enabled sound generator 220 in communication across a Bluetooth interface with the audio device 10, data from that communication (e.g., beam direction etc.) may be utilized to determine the relative location of the sound generator 220. The audio device 10 may further be provided with one or more sensors or switches configured to indicate, sense or detect at what state the audio device 10 is operating. This is specifically beneficial for audio devices 10 that are reconfigurable such that they may operate either as e.g., an in-ear or an earbud depending on configuration.

The method further comprises generating 340 a first internal sound Si based on the processed digital representation of the first specific external sound Se. This is performed by the audio device 10 when it is worn by the specific user 40. Simply put, the audio device 10 sounds the processed version of the first external sound Se such that the specific user 40 will perceive it. I.e., the transduced circuit 12 of the audio device is configured to sound the processed version of the first external sound Se.

In order to personalize the initial set of frequency dependent processing parameters 123, feedback data 301 relating to the generated first internal sound Si is advantageous. To this end, the method 300 further comprises obtaining 350 first feedback data 301 relating to the first internal sound Si. The first feedback data 301 is preferably indicative of a similarity between the first internal sound Si and the first specific external sound Se. The first feedback data 301 may be provide as previously indicated by the specific user 40 and/or by the feedback microphone 16 (if present) of the audio device 10. Some specific examples of feedback data 301 will be provided in other sections of the present disclosure.

The method 300 further comprises adjusting 360 the initial set of frequency dependent processing parameters 123 based on the first feedback data 301. The adjusted set of frequency dependent processing parameters 123 may be described as the personalized set of frequency dependent processing parameters 125. To provide a very simple example, if the specific user 40 indicate that a volume of the first internal sound Si is low compared to the first specific external sound Se, the adjustment may comprise increasing a gain of the personalized frequency dependent processing parameters 125 compared to a gain provided by the initial set of frequency dependent processing parameters 123.

The method 300 may further comprise providing 370 the personalized set of frequency dependent processing parameters 125 as ASP calibration data 303 for subsequent ASP processing. This ASP calibration data 303 will be specific for the specific user 40 and the audio device 10.

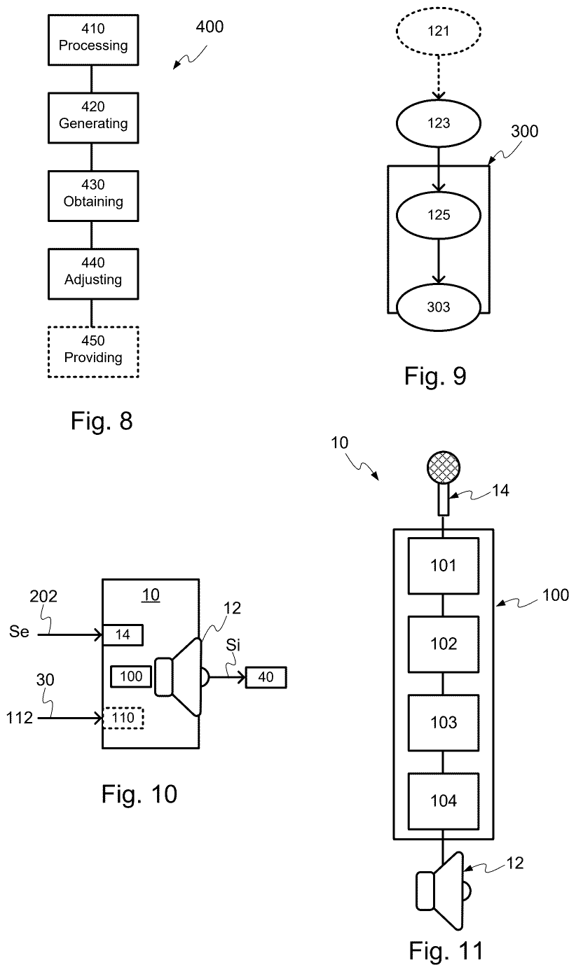

As already indicated, parts of, or the whole method 300 may be iterated a plurality of times such that further feedback data 301 related to additional extern sounds Se may be obtained and the ASP calibration data 303 may be updated accordingly. In some embodiments, or, if applicable, iterations of the method 300, the method 300 may further comprise an iterative method 400, see FIG. 8. The iterative method 400 is beneficial as it allows feedback to be provided also on internal sound Se with the personalized set of frequency dependent processing parameters 125 applied.

To this end, the iterative method 400 comprises processing 410 of the digital representation of the first external sound Se based on the personalized set of frequency dependent processing parameters 125. This may be done analogues e.g., to the processing 330 of the obtained first specific external sound Se as described above. It should be mentioned that this may be applied also to further external sounds Se if more than one external sound Se is utilized in providing the ASP calibration data 303. The method 400 further comprises generating 420 a personalized first internal sound Si′ based on the personalized processed digital representation of the first specific external sound Se. This may be done analogues e.g., to the generation 340 of the first internal sound Si as described above. Further to this, the iterative method 400 comprises obtaining 430 updated first feedback data 301′. This may be performed analogues to obtaining 350 the first feedback data described above. The updated first feedback data 301′ is advantageously indicative of a similarity between the personalized first internal sound Si′ and the first specific external sound Se. Further to this, the iterative method 400 may comprise adjusting 440 the personalized set of frequency dependent processing parameters 125 based on the updated first feedback data 301. Optionally, in some embodiments, the iterative method 400 may comprise providing 450 the personalized set of frequency dependent processing parameters 125 as ASP calibration data 303 for subsequent ASP processing.

The iterative method 400 may be run once or a plurality of times. In, for instance embodiments wherein the audio device 10 comprises the feedback microphone 16, the personalization process, or parts of the personalization process, may be performed without the specific user 40 actively providing feedback data 301. This allows the method 300, and/or the iterative method 300 to be run autonomously without interaction from the specific user 40. It may be advantageous to have the specific user to initiate and/or setup the calibration, but outside of that, the methods 300, 400 may be autonomously executed.

In some embodiments, iterations of the calibration method 300 of the iterative method 400 may comprise an averaging functionality and/or control functionality such as a product part, an integer part and/or a derivative part when providing the personalized set of frequency dependent processing parameters 125.

FIG. 9 shows a simplified diagram of how the ASP calibration data 303 may be provided based on the teaching of the present disclosure. As indicated above, the initial set of frequency dependent processing parameters 123 may be a predetermined set of parameters. Optionally, the initial set of frequency dependent processing parameters 123 may additionally, or alternatively, be based on the one or more calibration input parameters 121. The initial set of frequency dependent processing parameters 123 are provided to the method 300 for providing personalized ASP calibration data 303 and optionally also to the iterative method 400. From the method 300 for providing personalized ASP calibration data 303 (or the iterative method 400), the personalized ASP calibration data 303 is provided.

In the following, further technical features, examples and embodiments will be presented. These may be combined and utilized with any suitable device or method disclosed herein.

Based on the teachings presented herein, an advantageous embodiment of an audio device 10 will be presented with reference to FIG. 10. The audio device 10 may be any audio device 10 presented herein such as the audio device in FIG. 3. The audio device 10 is configured to form part of the ASP calibration system 200 presented with reference to FIG. 4 and FIGS. 5a-d. To this end, depending on the specific embodiment, the audio device 10 comprises the features required by an audio device 10 in order to form part of the different examples of ASP calibration systems 200. Specifically, the audio device 10 comprises the feed forward microphone circuit 14 in order to obtain digital representations of external sound, the transducer circuit 12 in order to provide the internal sound Si and the processor circuit 100 in order to perform suitable processing. When forming part of the ASP calibration system 200, the audio device 10 may obtain ASP calibration data 303 associated with a specific user 40 (and itself).

Optionally, the audio device 10 may be configured to process digital representations of external sound Se based on the ASP calibration data 303 and sound the processed external sound Se by means of the transducer circuit 12. This allows the audio device 10 to run in a personalized ASP mode where the ASP is processed based in the obtained ASP calibration data 303. In this mode, the specific user 40 will be less affected by any negative impact the audio device 10 will have on external sounds Se compared to when used in a non-personalized ASP mode. Further to e.g., comfort for the specific user 40, this increases the safety of the specific user 40 as the risk of not hearing or misinterpreting traffic sounds is decreased.

The audio device 10 may further comprise the input circuit 110. The input circuit 110 is, as previously explained, configured to obtain audio data 112 across the audio interface 30. The processor circuit 100 is generally configured to sound the audio data 112 by means of the transducer circuit 12 which would constitute a normal operation of an audio device 10. However, the present audio device 10 combines the audio data 112 with the processed external sound Se such that the specific user 40 will experience surrounding sounds and the audio data 112 (a favorite song or audio book) at the same time.

It should be mentioned that the processor circuit may further be configured to process the audio data 112 and/or the external sound Se based on a hearing profile of the specific user 40. The processing of audio streams by a hearing profiles is known and well described in the art. It should be mentioned that the hearing profile may, in addition to, or in place of, an audiogram of sorts describing the hearing of the specific user 40, comprise further details and preferences relating to the specific user 40. Such preferences may comprise, but are not limited to, a specific equalization settings associated with the specific user 40 (e.g., the bass should be increased). Different hearing profiles may be applied applied to the external sound Se compared to the audio data 112.

The methods 300, 400 and the features described herein may, as previously indicated, be either stereo or mono. Stereo processing may be performed on a plurality (two or more) of channels in serial or advantageously in parallel and output to two or more separate transducer circuits 12. Mono processing may be processing performed on one channel and output to one or more transducer circuits 12. As a guideline over-the-ear headphones are generally stereo while in-ear and ear-buds are mono, i.e., one channel per ear. However, in some embodiments, one ear-bud/in-ear of a pair of ear-bud/in-ear is configured to perform processing also for the other ear-bud/in-ear and send processed data to other ear-bud/in-ear. All these variants are well within the scope of the present disclosure.

With reference to FIG. 11, a modular view of an audio device 10 and associated processor circuit 100 is shown. The modular view of the audio device 10 is an exemplary, non-limiting, view provided to exemplify where the personalized ASP may be provided. As before, the audio device 10 comprises the feed forward microphone circuit 14 and the transducer circuit 12, wherein the processor circuit 100 is configured to process a signal from the feed forward microphone circuit 14 before it is provided to the transducer circuit 12. A first module 101 may be a noise reduction module 101, a second module 102 may be a filter module 102, a third module 103 may be a dynamic amplification module 103 and a fourth module 104 may be a personalization filter 104. The modules 101, 102, 103, 104 are preferably implemented in software, but may in some embodiments, be combinations of software and hardware. It should be mentioned that the modules 101, 102, 103, 104 may be arranged in any suitable order, and some may be arranged in parallel. The method 300,400 for personalization described herein, the initial set of frequency dependent processing parameters 123, the personalized set of frequency dependent processing parameters 125 and the ASP calibration data 303 may be associated with one or more of the modules 101, 102, 103, 104. Generally any module 101, 102, 103, 104 may be personalized, but the filter module 102 is commonly configured by a vendor of the audio device 10 and considered a factory default filter module 102. As a consequence, in some embodiments, the filter module 102 is not personalized by the teachings of the present disclosure but rather left at its default setting, i.e., the initial set of frequency dependent processing parameters 123 of that module 102 are not personalized by the teachings herein. The dynamic amplification module 103 and the noise reduction 101 may be configured in part by default factory settings and in part by the personalization presented herein. That is to say, some of the initial set of frequency dependent processing parameters 123 of these modules 103, 101 may be personalized and other parameters of the initial set of frequency dependent processing parameters 123 are left at a default setting (factory setting, predetermined setting etc.). The personalization filter 104 is generally personalized and configured based on the teachings presented herein, i.e. the initial set of frequency dependent processing parameters 123 relating to the personalization filter 104 may all, or at least to a significant part, be personalized by the teachings presented herein.

The personalization filter 104 may be described as comprising two parts, a first part, a personalization filter denoted H(f) is (iteratively) configured, constructed and/or updated according to the teachings of the present disclosure. A second part of the personalization filter 104 may be a temporary filter denoted T(f) which may be updated during part(s) of the personalization process and e.g., reset at a start of each part.

Initially, i.e. before any personalization is performed, the noise reduction module 101, the filter module 102 the dynamic amplification module 103 are configured with the initial set of frequency dependent processing parameters 123 which may comprise a factory default configuration provided by a vendor of the audio device. The initial set of frequency dependent processing parameters 123 may be provided by means of acoustic measurement equipment e.g., Head-and-Torso Simulator (HATS) with conventional ear simulator. Such equipment may have a measurement bandwidth of e.g., from about 20 Hz to 10 kHz but larger bandwidths are commonplace and bandwidths from about 20 Hz up to 20 kHz or even higher may be considered.

There exist a number of methods to configure the ASP using HATS such that a set of KPI measurements are approximately equal when compared after measuring with open and occluded ear, respectively. This may comprise e.g., directional free field measurements over a set of point source positions and an averaging process to weight all sub-results into a final open ear and occluded ear frequency response, respectively. Other methods may comprise diffuse field measurement with open and occluded ear, respectively. One exemplary method is disclosed in U.S. Pat. No. 10,951,990 B2. These methods are suitable in providing a factory default configuration, e.g., the initial set of frequency dependent processing parameters 123 as presented herein. However, this factory default is valid for the audio device 10 and is not adapted for a specific user 40. This is addressed by the teachings of the present disclosure.

It should be mentioned that the initial set of frequency dependent processing parameters 123 are advantageous as the specific user 40 would otherwise be forced to start the personalization process from scratch. This is for sure possible, but would prove to be tedious and even difficult to complete. In this aspect, the personalization process, i.e., the method 300 presented herein may be seen as the individualization of the factory default and therefore require only minor adjustment—not complete characterization of the individual hearing capability of the specific user 40 and/or the audio device 10.

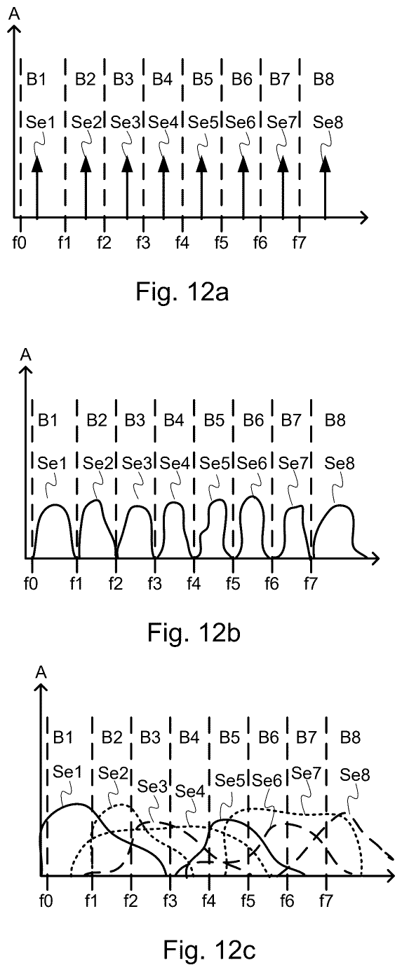

The personalization filter 104 may be configured with a bandwidth corresponding to the auditory range of human hearing, approximately 20 Hz to 20 kHz. As previously indicated, performing e.g., pure-tone audiometry across this bandwidth would be very tedious and time consuming for the specific user having to endure it. To this end, the bandwidth of the personalization filter 104 may be divided into frequency bands. This is schematically shown in FIGS. 12a-c wherein the bandwidth is divided into eight frequency bands B1-B8. This is beneficial for a duration of the personalization process (i.e., a duration of the method 300) and also the computational complexity when determining the personalized set of frequency dependent processing parameters 125. The frequency division (partitioning) into frequency bands B1-B8 may form a trade-off between complexity, accuracy and duration of the personalization process.

It should be mentioned that eight frequency bands B1-B8 is one example and any suitable number of frequency bands may be utilized. Many frequency divisions are available, e.g., octave band division, ⅓ octave band division, a combination of these or other division for different ranges of the bandwidth.

In this example, for the sake of completeness, a first frequency band B1 is defined between a lower frequency f0, e.g. 20 Hz, and a first frequency f1. A second frequency band B2 is defined between the first frequency f1 and a second frequency f2. A third frequency band B3 is defined between the second frequency f2 and a third frequency f3. A fourth frequency band B4 is defined between the third frequency f3 and a fourth frequency f4. A fifth frequency band B5 is defined between the fourth frequency f4 and a fifth frequency f5. A sixth frequency band B6 is defined between the fifth frequency f5 and a sixth frequency f6. A seventh frequency band B7 is defined between the sixth frequency f6 and a seventh frequency f7. An eighth frequency band B8 is defined between the seventh frequency f7 and an upper frequency (not shown), e.g. 20 kHz. The frequency bands B1-B8 may all have the same bandwidth, some may have the same bandwidth and other (or all) may have individual bandwidths.

The inventors have realized that a partitioning that is advantageous and keeps the specific user 40 focused and active during the personalization process and still produce an acceptable accuracy at a reasonable personalization process duration may be provided by the division outlined in the following. The first frequency band B1 may define a sub-bass region. To exemplify, the first frequency f1 may be at approximately 70 Hz. The second frequency band B2 may define a bass region. To exemplify, the second frequency f2 may be at approximately 250 Hz. The third frequency band B2 may define a low mid region. To exemplify, the third frequency f3 may be at approximately 500 Hz. The fourth frequency band B4 may define a mid mid region. To exemplify, the fourth frequency f4 may be at approximately 2 kHz. The fifth frequency band B5 may define an upper mid region. To exemplify, the fifth frequency f5 may be at approximately 4 kHz. The sixth frequency band B6 may define a presence region. To exemplify, the sixth frequency f6 may be at approximately 6 kHz. The seventh frequency band B7 may define a details region. To exemplify, the seventh frequency f7 may be at approximately 12 kHz. The eighth frequency band B8 may define a brilliance region.

It should be mentioned that the above presented frequency ranges, sub-bass (approximately 20 to 60 Hz), bass (approximately 60-250 Hz), low mid (approximately 250-500 Hz), mid mid (approximately 0.5-2 kHz), upper mid (approximately 2-4 kHz), presence (approximately 4-6 kHz), details and brilliance (approximately 6-20 KHz) are well known to the skilled person. The frequency bands B1-B8 do not necessarily match these frequency ranges, but these ranges are a common definition usable for illustrative purposes. Further to this, there are plenty of sounds to choose from for each frequency range and the examples given within the present disclosure are non-exhaustive. Further non-limiting examples of suitable specific external sounds Se, Se1-Se8 for the frequency ranges comprise:
Bass: drumbeats from the bass drum, bass guitar accords, etc.
Low mid: acoustic guitar accords, male voices, etc.
Mid mid: male or female voices, electric guitar chords, bird song etc.
Upper mid: male or female voices, electric guitar chords, etc.
Presence: high-hat beats, cymbal beats, tenor song, etc.
Details: bird song, soprano song, piano chords, sound effects, etc,

In FIG. 12a, one external sound Se1-Se8 is provided for each frequency band B1-B8. These specific external sounds Se1-Se8 are, in FIG. 12a, illustrated as single frequency specific external sounds Se1-Se8 which would be the case if e.g., the teachings of the present disclosure may very well be performed with one or more specific external sounds Se1-Se8 being single frequency sounds.

What the inventors have further realized is that it is advantageous to configure specific external sound Se1-Se8 for each frequency band B1-B8. This is shown in FIG. 12b. The inventors have further realized that selection of external sounds Se, e.g., audio files, plays an important role in a quality of the ASP calibration data 303 provided by the calibration method 300. This is especially true in embodiments wherein the specific user is asked to provide feedback 301 enabling adjustment of the initial set of frequency dependent processing parameters 123 such that a difference between the sounds of the open and occluded ear is reduced. From this follows that any instructions prompting the specific user 40 to provide feedback 301 is advantageously clear and suitable such that the user may easily comprehend what is requested and how to complete the request (what feedback 301 is expected).

There are, as the skilled person is well aware, many complex terms in the nomenclature of the audio industry and many of them are not know to non-skilled person e.g., “warm sound”, “wet sound”, “high frequency” etc. Further to this, the inventors have realized that the quality and accuracy of the feedback 301 provided by the specific user 40 will increase if the specific external sound Se, Se1-Se8 is a sound that the specific user 40 can relate to, that is to say, the specific user 40 e.g., recognizes, is familiar with and/or knows the specific external sound Se, Se1-8 beforehand.

To this end, the inventors have formed embodiments wherein several audio files, e.g. external sounds Se are created for each part of the personalization process and detailed later for the frequency division. This is schematically shown in FIG. 12b wherein a specific external sound Se1-Se8 is provided for each frequency band B1-B8. Rather than being single frequency sounds, the specific external sound Se1-Se8 are configured with a frequency content that matches, is contained within, the associated frequency band B1-B8. To exemplify, for the lower ranges e.g., the first frequency band B1 to the third frequency band B2, specific external sounds Se comprising e.g., suitable drumbeats, bass riffs and/or suitable combinations of low frequency signals. For the mid ranges e.g., the third frequency band B3 to the sixth frequency band B6, specific external sounds Se comprising e.g., suitable guitar, voices, and/or suitable combinations of mid frequency signals. For the high ranges e.g., the sixth frequency band B6 to the eighth frequency band B8, specific external sounds Se comprising e.g., bright instruments with high frequency harmonics are suitable such as high-hats drums, piano notes and/or suitable combinations of high frequency signals.

The inventors have further realized that the audio signals, i.e. the specific external sounds Se are not necessarily bandlimited according to e.g. the frequency bands B1-B8 of the personalization filter 104. This is shown in FIG. 12c wherein for instance the fourth specific external sound Se4 has a bandwidth starting between the lower frequency f0 and the first frequency f1 and ending between the fifth frequency f5 and the sixth frequency f6. This is beneficial as the user may perceive recognizable sounds negatively as they would appear band limited or distorted if they were limited to a specific frequency band B1-B8.

The selection of specific external sounds Se, Se1-Se8, i.e., audio signals, based on non-exclusive properties is advantageous as it is preferable to have a plurality of different specific external sounds Se, Se1-Se8 with only slightly different properties but all related to the frequency band B1-B8 of testing.

In some embodiments, it may be advantageous at low frequencies, e.g., below 70-100 Hz, to reduce any processing to save on resources. Low frequencies may be challenging to isolate and reproduce which means that reducing the processing (or not processing at all) for low frequencies may be implemented without significant changes in ASP quality.

Similarly, at high frequencies, e.g. above 12 kHz leakage between the audio device 10 and the cavity C may increase and reduced processing or no processing may be implemented without significant adverse effects to the ASP quality. Further, generally, above 12 kHz there is little information that will increase the user perception and these frequencies may, for simplicity, be removed by e.g., low pass filtering.

As a non-limiting detailed implementation example of the method 300, a personalization process according to the present disclosure will be described in the following.

The specific user is located in front of the sound generator 220 wearing the audio device 10 running a software application on the audio device 10, a mobile phone and/or the calibration processing circuit 210. The software application may be configured to indicate to the specific user 40 that she should be standing still while the process is recording.

The calibration process may start by checking a connection to the sound generator 220. This may be performed by processes known in the art where a suitable control device 10, 20, 100, 210 configures the sound generator 220 to emit a well-known, uniquely identifiable signal e.g., chirp or pseudo random sequence signal, and causes the audio device 10 to active recording on the feed forward microphone circuit(s) 14. The audio device 10 may be configured to analyze the recorded signal e.g., find correlation with the source signal (may be stored in the audio device 10) or audio device 10 may relay recorded data (compressed or uncompressed, or in analysis form) to the control device 10, 20, 100, 210 for analysis and/or detection and identification. Generally, this is not a time-critical stage and one would not need to consider power consumption at this stage. If a positive detection and identification is made, the sound generator 220 is determined to be sufficiently close to the audio device 10. If not, the specific user 40 may be instructed to follow a set of pre-defined actions in order to obtain a positive detection and identification. Such pre-defined actions may comprise checking connections between system components, move closer to the sound generator 200 etc. Further, if the (by the feed forward microphone circuit 14 on the audio device 10) recorded signal have a signification part of noise or disturbing signals, the specific used may be asked to mitigate these sources.

Once the sound generator 220 is identified, the process may proceed to check signal quality. As an acoustic environment (room, room interior etc.) and a relative positon of the specific user 40 and the sound generator 220 are unknown, it is beneficial to ensure that the sound that is rendered by the sound generator 220 is received correctly by the feed forward microphone circuit 14 of the audio device 10. To this end, the control device 10, 20, 100, 210 may be configured to cause rendering of a known signal on the sound generator 220 and a notification to the audio device 10 to record the ambient sound using the feed forward microphone circuit 14. The known signal preferably covers a bandwidth of operation (in the example here in 70 Hz-12 kHz) e.g., white noise, pink noise or pseudo-random sequence signals. A set of KPIs e.g., spectral flatness, minimum and maximum energy, peak, dips maximum amplitudes, etc., may be defined per frequency band B1-B8. These KPIs are preferably properties that relate the recorded sound rather than the source sound. If these KPIs are not fulfilled, the specific user may be engaged according to a predefined set of actions similar to the ones given above with regard to the connection to the sound generator 220. To exemplify, if noise and/or disturbances are detected, the specific user 40 may be asked to remove or mitigate the source of the same. If signal levels are low, the specific user 40 may be asked to move closer or increase a volume of the sound generator 220. If comparably deep peaks or dips are detected in the recorded spectrum, the specific user 40 may be asked to rearrange the setup e.g., move the sound generator 220 if located near a wall and/or position herself differently in the area. When the KPIs deemed necessary are met, e.g., above a pre-defined set of thresholds (one per KPI or a weighted common threshold), a quality of the sound environment is determined to be good, and the specific user 40 may be instructed to slightly turn to the side and the procedure restarts. A number of times the specific user 40 is instructed to turn may be configured as a trade-off between sound quality, measurement result accuracy and duration of the personalization process. Advantageously, at least one position with frontal incident sound (sound generator 200 located in front of the specific user 40) is provided, and preferably in combination with an additional 2-4 different relative positions between the specific user 40 and the sound generator 200 such as turned 45 and 90 degrees to the left and right, respectively. A higher number of positions is advantageous in order to provide a suitable average value of the ambient sound recoding quality with comparably low sensitivity to sound direction, such that a single sound direction is not too prominent. Further, averaging over a plurality of directions is good but, a set of 3-5 measurements including front-, left-, and right-direction have been proven to be sufficient. At each position, the control device 10, 20, 100, 210 may be configured to handle a timing between interacting and instructing the specific user 40, rendering audio signal on transducer, notifying the audio device 10 to record and receive from the audio device 10 recorded sound for analysis or analyzed data directly.

During the checking of the signal quality, the system 200 may be configured to store an estimate of the acoustic transmission response as outlined in the following. The received microphone signal (frequency domain representation) is Sₘ(f) and a source signal is S(f), then:

$${S}_{m} ( f ) = M ( f ) HRTF ( f ) R ( f ) {T}_{R} ( f ) S ( f )$$

where M(f) is the microphone frequency response, HRTF(f) is the Head-Related-Transfer-Function of the specific user at the current setup, R(f) is the frequency transfer of the room (frequency representation of the Room Impulse Response), and T_{R}(f) is the frequency response of the transducer. The microphone frequency response M(f) is generally a stable property that is known to a certain degree of uncertainty depending on e.g. a hardware tolerance and commonly stored in the audio device 10. Hence, the frequency response of sound propagation from and including the transducer to the headphones may be described as:

$${H}_{sp} ( f ) = \frac{\frac{1}{K} {\sum }_{K} {S}_{m} ( f )}{S ( f )}$$

Where k is the number of positions the specific user 40 was asked to stand in. As the skilled person will understand, since a typical set of in-ear headphones occupy more space in the ears than a typical measurement microphone, the HRTF(f) is not exactly the true HRFT of the specific user 40, but a good approximation.

Once all positions are approved according to KPIs, the specific user 40 may be prompted to continue with the personalization process 300. The specific user 40 may be asked to detail some information regarding her ears. These calibration input parameters 121 may be provided in order to determine the initial set of frequency dependent processing parameters 123. Generally, this may be provided in much detail by e.g., taking a photo and identifying based on and by the control device 10, 20, 100, 210, what type of HRFT would be suitable. The specific user 40 may be asked to state which sleeves that are used on the audio device 10, the sleeves are typically defined as small, medium or large size where one of the three is factory default (mounted at the factory). Based on which sleeve that is used, the system 200 may model the ear-canal 42 of the specific user 40, this will be detailed in coming sections.

The specific user 40 may be prompted to start a personalization process. At a start of the process, the specific user 40 is wearing the audio device 10 and ASP of the audio device 10 is configured to be activated. The specific user 40 may be instructed to locate herself in front of the sound generator 220 but may additionally, or alternatively, be instructed to turn in a similar manner as that when checking the signal quality in order to average over several directions. At any suitable point in time, the specific user 40 may remove the audio device 10 (one or both) in order to listen to the sound generator 220 (the specific external sound Se) with open (un-occluded) ears and perceive how it sounds without occlusion. One part of the process may start with a first specific external sound Se being rendered by the sound generator 220. As described, there may be several specific external sound per part to select from. A graphical user interface (GUI) may be updated to display controls that the specific user 40 may interact with to change the ASP processing, i.e. update/change the personalized set of frequency dependent processing parameters 125. The specific user 40 may be asked to interact with the controls of the GUI and listen to the specific internal sound Si rendered by the audio device 10. The specific user 40 may adjust controls of the GUI and thereby change processing of the rendered audio signal until she is satisfied. The specific user 40 may further be prompted to grade a perceived quality of the specific internal sound Si and continue to a next part or end the process. Once the specific user 40 is done with one part, the personalized set of frequency dependent processing parameters 125 may be weighted together with any previous personalized set of frequency dependent processing parameters 125 or the initial set of frequency dependent processing parameters 123, and the ASP calibration data 303 is updated accordingly. After personalization is completed, the specific user 40 may be asked to adjust a level/volume in order to get the overall sound level correct. The ASP calibration data 303 are applied to the audio device 10, and advantageously also stored locally and/or on the cloud.

The inventors have further realized that, in embodiments wherein the specific user 40 is providing at least part of the feedback data 301, it is advantageous if this may be provided in an intuitive manner which does not require the skills and experience of an audio engineer. To this end, the specific user 40 may provide the feedback data 301 as two dimensional feedback data.

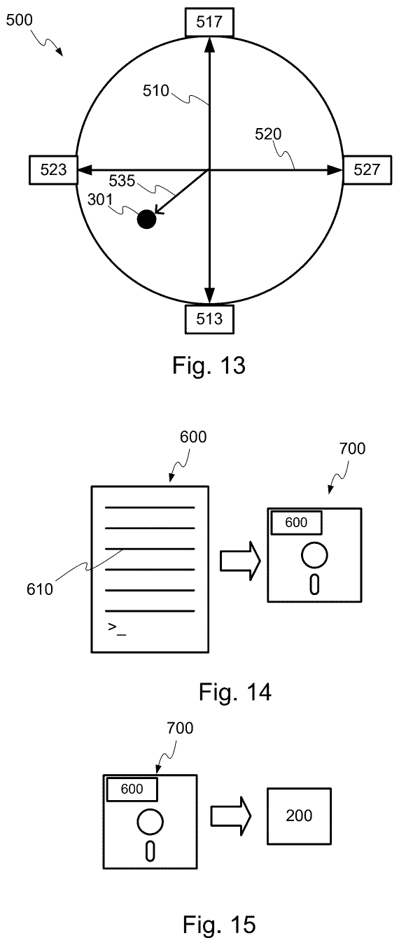

In FIG. 13, an exemplary two dimensional space 500 for representing feedback 301 is shown. The two dimensional space 500 comprises a first dimension 510 and a second dimension 520. The feedback data 301 may be described as e.g. a point in the two dimensional space 500, or as a vector 535 in the two dimensional space 500. The first and second dimension 510, 520 may represent different parameters usable in describing the internal sound Si, i.e. a similarity between the internal sound Si and the external sound Se or a similarity between the perceived sound with and without the audio device 10 (occluded and non-occluded ear). The parameter represented by each dimension 510, 520 may differ depending on a stage in the personalization process, e.g., the method 300. The first dimension 510 describes a first parameter between a first parameter first value 513 and a first parameter second value 517. The second dimension 520 describes a second parameter between a second parameter first value 523 and a second parameter second value 527.

Advantageously, one of the dimensions 510, 520 represents amplitude feedback data configured to indicate a similarity in sound pressure level (SPL) between perception of the internal sound Si and the external sound Se. However, specific users 40 may not be comfortable in providing feedback in terms of an SPL. Therefore, the similarity in SPL may be provided by more manageable terms that the specific user 40 may be more comfortable with. Assume that the SPL is described by the first dimension 510, in order to simplify the task of providing feedback data 301, the first parameter first value 513 may indicate that the perceived internal sound Si is “weaker” compared to the external sound Se. Similarly, the first parameter second value 517 may indicate that the perceived internal sound Si is “louder” that the external sound Se. This means that the specific user 04 will provide feedback between two subjective extremes being e.g. “weak” and “loud”.

Similarly to the SPL, the other dimension 510, 520 may be configured to provide an indication of another parameter of the internal sound Si. To this end, the first value 513, 523 and the second value 517, 527 of the other dimension 510, 520 may be defined as an emotional indicator, i.e. subjective indicators such as “bright”/“dark”, “deep”/“shallow” etc. The choice of the indicator to use may be dependent on a current frequency band B1-B8.

The feedback data 301 may further comprise a quality indicator provided by the specific user 40. The quality indicator may be an indicator configured to indicate an overall sound resemblance compared to the open-ear (preferred sound). The quality indicator may an indicator spanning from subjective terms such as “very different” to “the same”. The subjective quality indicator may be mapper of a numerical value, e.g. [0, . . . , 1] where e.g., 0.1 or below indicate poor, 0.5 indicate acceptable and 0.9 or above indicate good resemblance. The quality indicator may be represented as a slider bar on a user interface that the specific user 40 may manipulate.

It is advantageous to provide the two dimensional space 500 to the specific user 40 as a user interface on e.g. a touch display etc. This allows the specific user 40 to directly select a point describing the feedback data 301. Further to this, in some embodiments, the specific user 40 may drag, move or otherwise alter the feedback data 301 substantially continuous during the personalization process, e.g. as described by the iterative method 400. This allows the specific user 40 to manipulate the interface such that the initial set of frequency dependent processing parameters 123 or the personalized set of frequency dependent processing parameters 125 may be updated substantially in real time to reflect this. Further, substantially in real time, the personalized internal sound Si′ may be provided based on the personalized set of frequency dependent processing parameters 125 or updated personalized set of frequency dependent processing parameters 125 allowing the specific user to immediately perceive changes in the personalized internal sound Si′.

The following is given in order to provide a further specific non-limiting example of how to perform the method 300 and specifically to provide a substantially real-time update of the personalized internal sound Si′ based on the feedback data 30.

The temporary filter T(f), and thereby the ASP processing may be changed by the specific user 40 by altering the feedback data 301, advantageously via a (graphical) user interface. In some examples, the temporary ASP processing is not accounted, i.e. provided as the personalized set of frequency dependent processing parameters 125 or the ASP calibration data 303 until the quality indicator is set. It should be mentioned that there are numerous ways in which the feedback data 301 may be processed, and these may depend on e.g., type of feedback data 301, implementation etc. Considering the two dimensional space of FIG. 13, assume that the first dimension 510, a y-axis, represent amplification for a specific frequency band B1-B8 and that a shape of the temporary filter T(f) may be adjusted by manipulation along the second dimension 520, an x-axis. As an example, if the x-value is more towards a “brighter” emotional indicator, this may result in increased high-frequency content compared to low-frequency content. Vice versa, a result towards a “darker” emotional indicator may amplify lower frequencies more than higher frequencies. A personalization filter 104, or temporary filter T(f) may be provided for each frequency band B1-D8. The filter for each frequency band B1-D8 may be provided with a gain being linear versus frequency, wherein a slope of the gain may be controlled by the brighter/darker emotional indicator. A frequency range of the filtering may be determined depending on which part of the personalization process that is currently being performed. This is advantageous since each part may target a specific frequency band B1-B8 of the ambient sound.

Each part of the spectrum may have an individual gain. However, in order to avoid saturation, a common amplification is advantageously implemented at an end of the personalization process. A final scaling (gaining) may be determined based on amplifications (gain) of each frequency band B1-B8 and an indication from the specific user 40 indicating an overall level adjustment. An average amplification level may be transferred to the dynamic amplification module 103, optionally comprising a limiter function. This is a common process to avoid audio distortion due to saturation inside filters. The filters are generally normalized at 0 dB, by e.g., removing the average level. The average level may be included by an amplification by a dynamic gain controller with/without limiter functionality (a component that can handle amplification while avoiding saturation). Consequently, most amplification will be provided by the dynamic amplification module 103, including e.g., a limiter while the relative spectrum differences are obtained by the filtering process.

Assume that a specific user 40 has graded a number of specific external sound Se in parts of the personalization process. A temporary ASP processing may then be stored as Hₖ(f) for each specific externals sound Se, Se1-Se8 k, where k is the number of specific externals sound Se, Se1-Se8. The system 200 may be configured to store (on e.g., the ASP calibration processing circuitry 210, the audio device 10 etc.), the frequency response adjustment applied at each iteration Hₖ(f) and the weight obtained from the quality indicator Wk set by the specific user 40. A frequency response of the personalization filter 104 is determined as:

$$H ( f ) = \frac{{\sum }_{k = 1}^{K} {w}_{k} {H}_{k} ( f ) {g}_{k} ( f )}{{\sum }_{k = 1}^{K} {w}_{k}}$$

Hₖ(f) may be discretely defined as H(fₙ) where there are a total N frequency points (N may be set equal to the number of frequency band B1-B8). The personalization filter 104 may be updated with H(f).

As an optional embodiment, the personalization may further comprise a background ASP configuration. The background ASP configuration may be performed by any suitable processing circuit of the audio device 10 or the calibration system 200. During a time at which the specific user 40 is conducting the personalization process, the background ASP configuration circuit may be configured calculate a proposed adjustment of the temporary ASP filter T(f) as an alternative if the specific user 40 is unhappy with his/her selection. If the specific user 40 completes a part and set a poor quality indicator, the specific user 40 may be presented with an option of listening to and compare a temporary ASP filter T(f) determined by the background ASP configuration to the temporary ASP filter T(f) (the frequency dependent processing parameters 125) configured by the specific user 40. The specific user 40 may choose to keep his/her temporary ASP filter T(f) or switch to the temporary ASP filter T(f) determined by the background ASP configuration. If the specific user 40 changes the frequency dependent processing parameters 125, a new quality indicator is preferably provided by the specific user 40. The proposal determined by the background ASP configuration is advantageously calculated in the background while the specific user is configuring the temporary ASP filter T(f). The calculation is advantageously based on a frequency spectrum of the current (the sound the user is listening to) specific external sound Se, user information regarding the used sleeve of the audio device 10 and the sound propagation frequency function Hₛₚ(f). The background ASP configuration may determine a proposed temporary filter T_{BASP}(f) such that:

$$\frac{{E}_{c} ( f )}{{E}_{0} ( f )} ( L ( f ) + M ( f ) {H}_{BASP} ( f ) {T}_{r} ( f ) ) = 1$$

Where E_{c}(f) and E₀(f) are the frequency transfer functions for the occluded and open ear respectively. L(f) is the frequency transfer function for the leakage, M(f) is a frequency transfer function of feed forward microphone circuit 14, and Tₜ(f) is a frequency response of the transducer circuit 12. E_{c}(f) and E₀(f) may generally be modelled with good accuracy as a cylindrical waveguide having both ends closed or one open and one closed end, respectively. A diameter and length of the waveguide may be set by associating the sleeve size to a set of numbers that details the diameter and length. The leakage transfer function may be approximated by a fixed function of frequency obtained from e.g. measurement on HATS. For simplicity it may be estimated that L(f)=0 if the audio device 10 is determined to provide a good fit/seal. Further, L(f)=0 is a good approximation if nothing is known about the frequency transfer function for the leakage since the leakage (if the ear-buds are correctly inserted) is not the major contributing factor of sound character that the specific user 40 is alerted to. The solution to the equation provided above is known as a (regularized) least-square optimization problem.

Regarding the noise reduction module 101, a total gain applied to the recorded microphone signal may at times be comparably high. Depending on a signal to noise ratio (SNR) of the microphone 14, 16, a self-noise of the microphones 14, 16 may be hearable and annoying for the specific user. The specific user 40 may be prompted to move to a quite location. At the quite location, the specific user 40 may be presented with a slider that adjust an amount of noise reduction such that any low self-noise is decreased to a tolerable level. Generally, this may be provided by a slider showing a degree of noise reduction. Generally, 0-10 or up to 15 dB of noise reduction may be applied without any substantial adverse effects.

The present disclosure have presented numerous methods, examples, embodiments and features related to, among other things, personalizing of ASP. The teachings may be implemented wholly, or in part, by a computer program 600 as shown in FIG. 14. The computer program 600 comprises program instructions 610 which, when executed by a suitable control device 10, 20, 100, 210 or processor circuit 100, 210 cause that device 10, 20, 100, 210 or processor circuit 100, 210 to cause execution of any feature, method, example or embodiment presented herein. Specifically, the program instructions 610 are such that the cause the processor circuit 100 or the ASP processor circuit 210 to perform at least part of the either one or both of the methods 300, 400 presented with reference to FIGS. 7 and 8. As further illustrated in FIG. 14, the computer program 600 may be stored upon a computer-readable storage medium 700. Preferably, the computer-readable storage medium 700 is a non-volatile computer-readable storage medium 700 such as, but not limited to, a flash based memory device, a CD-ROM etc.

As illustrated in FIG. 15, the computer program 600 may be loaded onto a processor circuit 100, 210 via, as shown in FIG. 15, the computer-readable storage medium 700 or alternatively transferred across a network of computers. The computer program 610 is, in FIG. 15 shown being loaded onto the ASP calibration system 200. This is to imply that the computer program 610 may be loaded onto any suitable device of the ASP calibration system 200.

Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. For example, while embodiments of the invention have been described with reference a portable audio device 10, persons skilled in the art will appreciate that the embodiments of the invention can equivalently be applied to other audio playback devices as sound transfer into a vehicle or ear protective equipment. Furthermore, although specific terms may be employed herein, they are used in a generic and descriptive sense only and not for purposes of limitation. Therefore, a person skilled in the art would recognize numerous variations to the described embodiments that would still fall within the scope of the appended claims. Furthermore, although individual features may be included in different claims (or embodiments), these may possibly advantageously be combined, and the inclusion of different claims (or embodiments) does not imply that a combination of features is not feasible and/or advantageous. In addition, singular references do not exclude a plurality. Finally, reference signs in the claims are provided merely as a clarifying example and should not be construed as limiting the scope of the claims in any way.

1. A method for providing personalized ambient sound playback, ASP, calibration data associated with an audio device and a specific user, the method comprising:
generating, remotely from the audio device, a first specific external sound within a first frequency band;
obtaining, by the audio device, a digital representation of the first specific external sound;
processing the digital representation of the first specific external sound based on an initial set of frequency dependent processing parameters;
generating, by the audio device when worn by the specific user, a first internal sound based on the processed digital representation of the first specific external sound;
obtaining, from the specific user, first feedback data indicative of a similarity between the first internal sound and the first specific external sound;
adjusting the initial set of frequency dependent processing parameters based on the first feedback data and the first frequency band, thereby obtaining a personalized set of frequency dependent processing parameters;
repeating the steps of generating, obtaining, processing, generating and obtaining, for a second specific external sound within a second frequency band thereby obtaining second feedback data associated with the second specific external sound and the second frequency band,
wherein the personalized set of frequency dependent processing parameters are further adjusted based on the second feedback data and the second frequency band; and
providing the personalized set of frequency dependent processing parameters as ASP calibration data for the audio device when worn by the specific user.

2. The method of claim 1, wherein the first specific sound comprise frequency content also in the second frequency band and the second specific sound comprise frequency content also in the first frequency band.

3. The method of claim 1, wherein the first specific sound comprise a frequency content being substantially wholly within the first frequency band and the second specific sound comprise a frequency content being substantially wholly within the second frequency band.

4. The method of claim 1, wherein the first frequency band and the second frequency band are selected from a set of frequency bands comprising at least two of a sub-bass region, a bass region, a low-mid region, a mid-mid region, an upper-mid region, a presence region and a details region.

5. The method of claim 1, wherein the feedback data from the specific user is obtained by the specific user indicating feedback data in a two dimensional space wherein at least one dimension comprises an emotional indicator.

6. The method of claim 5, wherein the emotional indicator is configured based on the frequency band associated with the external sound related to the feedback data.

7. The method of claim 1, wherein obtaining the first feedback data comprises obtaining feedback data from a feedback microphone circuit of the audio device.

8. The method of claim 1, wherein the first feedback data comprises amplitude feedback data indicative of a similarity in sound pressure level, SPL, between the first internal sound and the first specific external sound.

9. The method of claim 8, wherein adjusting the initial set of frequency dependent processing parameters based on the first feedback data is further based on one or more equal loudness contours.

10. The method of claim 1, further comprising:
processing the digital representation of the first external sound based on the personalized set of frequency dependent processing parameters;
generating, by the audio device when worn by the specific user, a personalized first internal sound based on the personalized processed digital representation of the first specific external sound;
obtaining updated first feedback data indicative of a similarity between the personalized first internal sound and the first specific external sound; and
adjusting the personalized set of frequency dependent processing parameters based on the updated first feedback data.

11. The method of claim 1, wherein the initial set of frequency dependent processing parameters are based on one or more calibration input parameters, wherein the calibration input parameters are one or more of a worn state of the audio device and/or a relative location of a sound generator configured to generate the first specific external sound.

12. The method of claim 1, wherein the personalized frequency dependent processing parameters and the ASP calibration data are configured with a limited bandwidth, preferably, the limited bandwidth correspond an auditory bandwidth of humans.

13. The method of claim 12, wherein the personalized frequency dependent processing parameters and the ASP calibration data are set to unity such that no processing is performed at frequencies below 20 Hz, preferably at frequencies below 50 Hz and most preferably at frequencies below 70 Hz.

14. The method of claim 12, wherein the personalized frequency dependent processing parameters and the ASP calibration data are set to unity such that no processing is performed at frequencies above 20 kHz, preferably at frequencies above 15 KHz and most preferably at frequencies above 12 KHz.

15. The method of claim 1, wherein the first specific external sound is a predefined sound selected from a set of sounds comprising a plurality of sounds, wherein at least one of the sounds is suitable for determining ASP calibration data associated with at least one frequency band selected from of bass region, a low-mid region, a mid-mid region, an upper-mid region, a presence region and/or a details region.

16. An ASP calibration system comprising at least one processor circuit configured to cause execution, by the system, of the method of claim 1, wherein the system comprises:
a sound generator configured to generate specific external sound,
an audio device located remote from the sound generator and comprising a feed forward microphone circuit configured to obtain digital representations of specific external sound generated by the sound generator and a transducer circuit configured to generate internal sound when the audio device is worn by the specific user, and
a feedback provisioning circuit configured to obtain feedback data from the user.

17. An audio device configured to provide ASP calibration data of the audio device and a specific user, wherein the audio device comprises a feed forward microphone circuit, a transducer circuit, and a processor circuit, wherein the processor circuit is configured to cause execution of the steps of:—
obtaining, by the feed forward microphone circuit of the audio device, a digital representation of a first specific external sound within a first frequency band generated remotely from the audio device;
processing, by the processor circuit, the digital representation of the first specific external sound based on an initial set of frequency dependent processing parameters;
generating, by the transducer circuit when the audio device is worn by the specific user, a first internal sound based on the processed digital representation of the first specific external sound;
obtaining, by the processing circuit, first feedback data provided by the specific user through a feedback provisioning circuit, wherein the first feedback data is indicative of a similarity between the first internal sound and the first specific external sound;
adjusting, by the processing circuit, the initial set of frequency dependent processing parameters based on the first feedback data and the first frequency band, thereby obtaining a personalized set of frequency dependent processing parameters;
repeating the steps of obtaining, processing, generating and obtaining, for a second specific external sound within a second frequency band thereby obtaining second feedback data associated with the second specific external sound and the second frequency band,
wherein the personalized set of frequency dependent processing parameters are further adjusted based on the second feedback data and the second frequency band; and
providing the personalized set of frequency dependent processing parameters as ASP calibration data for the audio device when worn by the specific user.

18. The audio device of claim 17, wherein the processor circuit is configured to process the digital representations of external sound based on the ASP calibration data and sound the processed external sound by means of the transducer circuit, preferably the processor circuit is further configured to process the external sound based on a hearing profile of the specific user.

19. The audio device of claim 17, further comprising an input circuit configured to obtain audio data across an audio interface, wherein the processor circuit is configured to sound the audio data by means of the transducer circuit, preferably the processor circuit is further configured to process the audio data based on a hearing profile of the specific user.

20. A computer-readable storage medium comprising program instructions which, when executed by a processor circuit, cause the processor circuit to cause the ASP calibration system to execute the method according to claim 1, wherein the ASP calibration system comprises:
a sound generator configured to generate specific external sound,
an audio device located remote from the sound generator and comprising a feed forward microphone circuit configured to obtain digital representations of specific external sound generated by the sound generator and a transducer circuit configured to generate internal sound when the audio device is worn by the specific user, and
a feedback provisioning circuit configured to obtain feedback data from the user.
